(19) United States
(12) Patent Application Publication
(10) Pub. No.: US 2017/0123127 A1
(43) Pub. Date: May 4, 2017

(54) MIXTURE, NANO FIBER, AND POLARIZED LIGHT EMISSIVE FILM

(71) Applicant: Merck Patent GmbH, Darmstadt (DE)

(72) Inventors: Masaki HASEGAWA, Kanagawa (JP); Stephan DERTINGER, Tokyo (JP)

(73) Assignee: Merck Patent GmbH, Darmstadt (DE)

(21) Appl. No.: 15/318,625

(22) PCT Filed: May 12, 2015
(86) PCT No.: PCT/EP2015/000975

§ 371 Date: Dec. 13, 2016

(30) Foreign Application Priority Data
Jun. 13, 2014 (EP) 14002045.4

(51) Int. Cl. G02B 5/30; B29D 11/00; B29D 7/01

(52) U.S. Cl. CPC G02B 5/3058; B29D 7/01; B29D 11/00807

(57) ABSTRACT

The present invention relates to polarized light emissive films, and to a preparation thereof. The invention also relates to use of the polarized light emissive film in an optical device. The invention further relates to an optical device and to a preparation thereof.

The invention further relates to a mixture comprising a plural of inorganic fluorescent semiconductor quantum rods, and to use of the mixture for preparing the polarized light emissive film.

The present invention furthermore relates to a polarized light emissive nanofiber, to use and to a preparation thereof.

### FIELD OF THE INVENTION

The present invention relates to polarized light emissive films, and to a preparation thereof. The invention also relates to use of the polarized light emissive film in an optical device. The invention further relates to an optical device and to a preparation thereof. The invention further relates to a mixture comprising a plural of inorganic fluorescent semiconductor quantum rods, and to use of the mixture for preparing the polarized light emissive film. The present invention furthermore relates to a polarized light emissive nanofiber, to use and to a preparation thereof.

### BACKGROUND ART

Polarization properties of light are used in a variety of optical applications ranging from liquid-crystal displays to microscopy, metallurgy inspection, and optical communications.

For example, international patent application laid-open No. WO 2012/059931A1, WO2010/089743 A1, and WO 2010/095140 A2, Tibert van der Loop, Master thesis for Master of Physical Sciences FNWI Universiteit van Amsterdam Roeterseiland Complex; Nieuwe achtergracht 166 1018WV Amsterdam, M. Bashouti et. al., “Chem Phys Chem” 2006, 7, p. 102-p. 106, M. Mohannadimasoudi et. al., Optical Materials Express 3, Issue 12, p. 2045-p. 2054 (2013), Tie Wang et al., “Self-Assembled Colloidal Superparticles from Nanorods”, Science 338 358 (2012), M. Bashouti et. al., “Alignment of Colloidal CdS Nanowires Embedded in Polymer Nanofibers by Electrospinning”, Chem Phys Chem 2006, 7, 102-106.

Light emissive fiber mat is also described in, for example WO 2008/063866 A1.

### PATENT LITERATURE

1. WO 2012/059931 A1
2. WO 2010/089743 A1
3. WO 2010/095140 A2
4. WO 2008/063866 A1

### Non Patent Literature

5. Tibert van der Loop, Master thesis for Master of Physical Sciences FNWI Universiteit van Amsterdam Roeterseiland Complex; Nieuwe achtergracht 166 1018WV Amsterdam
6. M. Bashouti et. al., “Chem Phys Chem” 2006, 7, p. 102-p. 106,
7. M. Mohannadimasoudi et. al., Optical Materials Express 3, Issue 12, p. 2045-p. 2054 (2013),
8. Tie Wang et al., “Self-Assembled Colloidal Superparticles from Nanorods”, Science 338 358 (2012)
9. M. Bashouti et. al., “Alignment of Colloidal CdS Nanowires Embedded in Polymer Nanofibers by Electrospinning”, Chem Phys Chem 2006, 7, 102-106

### SUMMARY OF THE INVENTION

However, the inventors newly have found that there is still one or more of considerable problems for which improvement is desired, as listed below.
1. Excellent in plane uniformity of light emission of a polarized light source is desired.
2. Thin polarized light source is needed.
3. Suitable polarization ratio as a thin polarized light source is required.
4. Good dispersibility of fluorescent semiconductor quantum rods in a solvent and/or in a polymer medium is still a need for improvement.
5. To expand a degree of freedom in selecting a polymer medium for a polarized light emitting moiety is required.

The inventors aimed to solve one or more of the aforementioned problems. Surprisingly, the inventors have found a novel polarized light emissive film (100), comprising a plural of nanofibers (110) aligned in one common direction; and a plural of inorganic fluorescent semiconductor quantum rods (120) aligned in the nanofibers approximately toward the long axis of the nanofibers, solves the problems 1 to 3 at the same time.

In another aspect, the invention relates to use of the said polarized light emissive film (100) in an optical device.

In another aspect, the invention further relates to an optical device (130), wherein the optical device includes a polarized light emissive film (100) comprising a plural of nanofibers (110) aligned in one common direction; and a plural of inorganic fluorescent semiconductor quantum rods (120) aligned in the nanofibers approximately toward the long axis of the nanofibers.

The present invention also provides for method for preparing the polarized light emissive film (100), wherein the method comprises the following sequential steps of:

(a) preparing a mixture containing the plural of inorganic fluorescent semiconductor quantum rods and a solvent;
(b) carrying out electro spinning with the mixture to form a nanofiber; and
(c) aligning the nanowire in a common direction to form the polarized light emissive film.

In another aspect, the present invention further provides for method for preparing the optical device, wherein the method comprises the step of:

(x) providing the polarized the polarized light emissive film into the optical device.

In another aspect, the invention also provides for a mixture comprising a plural of inorganic fluorescent semiconductor quantum rods having a surface ligand, polymer and solvent, wherein the surface ligand of the inorganic fluorescent semiconductor quantum rods is a polyalkylene amine; and the solvent is selected from the group consisting of hexafluoro-2-propanol (HFIP), a fluorophenol and a combination of any of these.

In another aspect, the present invention further provides for use of the mixture for preparing the polarized light emissive film.

In another aspect, the invention also provides for a polarized light emissive nanofiber containing a polymer and an inorganic fluorescent semiconductor quantum rod having a surface ligand, wherein the polymer is a water insoluble polyester group and the surface ligand is polyalkylene amine.

In another aspect, the present invention further provides for use of the polarized light emissive nanofiber.

In another aspect, the present invention also relates for method for preparing the polarized light emissive nanofiber, wherein the method comprises the following sequential steps of:

(a′) preparing a mixture containing the plural of inorganic fluorescent semiconductor quantum rods and a solvent; and
(b′) carrying out electro spinning with the mixture.

Further advantages of the present invention will become evident from the following detailed description.

### DESCRIPTION OF DRAWINGS

FIG. 1: shows a schematic of a polarized light emissive film (100), comprising a plural of nanofibers (110) aligned so that the polarized light emissive film can emit a polarized light; and a plural of inorganic fluorescent semiconductor quantum rods (120) aligned in one common direction.

FIG. 2: shows evaluation data of the polarized light emissive film of the working example 1.

FIG. 3: shows photo image of the polarized light emissive film of the working example 1.

FIG. 4: shows a schematic of electrospindle equipment.

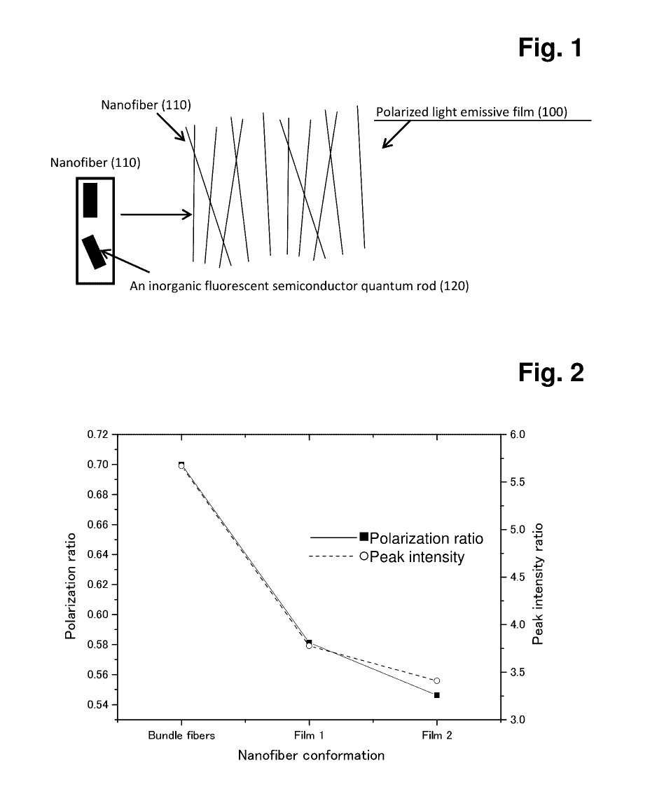

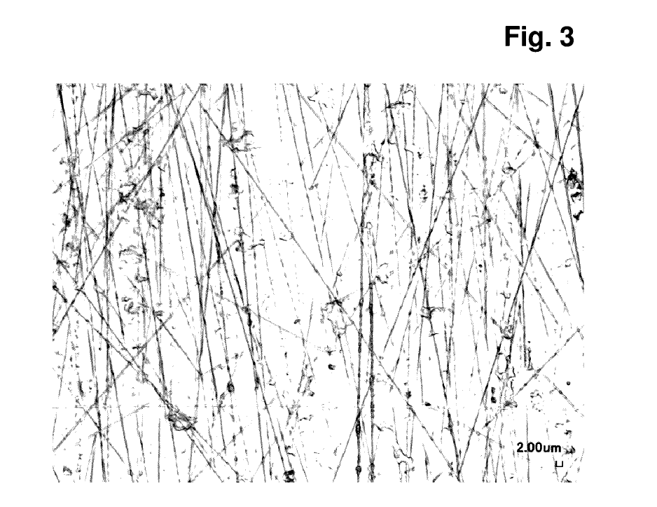

### LIST OF REFERENCE SIGNS IN FIG. 1

100. a polarized light emissive film
110. a plural of nanofibers
120. a plural of inorganic fluorescent semiconductor quantum rods

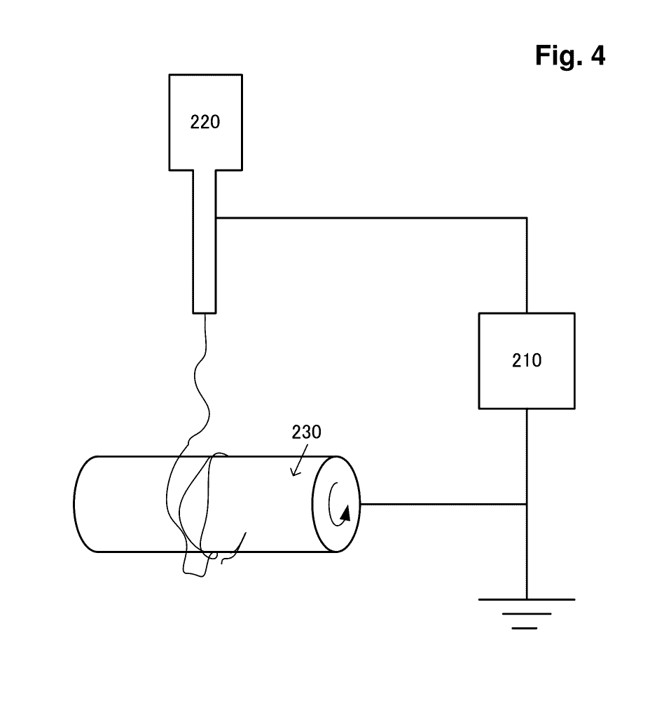

### LIST OF REFERENCE SIGNS IN FIG. 4

210. a high voltage source
220. an electrospinning unit
230. an aligner

### DETAILED DESCRIPTION OF THE INVENTION

In a general aspect, a polarized light emissive film (100), comprising a plural of nanofibers (110) aligned in one common direction; and a plural of inorganic fluorescent semiconductor quantum rods (120) aligned in the nanofibers approximately toward the long axis of the nanofibers.

In a preferred embodiment of the invention, wherein the polarized light emissive film emits a polarized light upon irradiation with a wavelength shorter than that of the emitted light.

Average of orientation dispersion of the long axis of the nanofibers of the polarized light emissive film can be determined by a comparison of polarization ratio of a straight single nanofiber in the film and the polarized light emissive film.

Polarization ratio of each straight single nanofiber “PRs” can be determined by using optical fluorescent microscope equipped with a spectrometer, and the symbol “PRs” also represents a degree of orientation order of quantum rods in the nanofiber.

According to the present invention, to calculate a value of average PRs of nanofibers, 10 nanofibers in the film are measured and averaged the value of each PRs.

The symbol “Sf” means a degree of orientation order of nanofibers in a polarized light emissive film, and polarization ratio of the polarized light emissive film “PRf” can be determined by following equation formula (I).

PRf=average PRs×Sf (I)

If all nanofibers aligned to same direction perfectly, Sf=1, and PRf=average PRs. Sf can be calculated by Sf=PRf/average PRs.

The polarization ratio of light emission from the polarized light emissive film of the present invention also can be evaluated by polarization microscope equipped with spectrometer.

For example, the polarized light emissive film is excited by light source such as a 1 W, 405 nm light emitting diode, and the emission from the films is observed by a microscope with a 10 times objective lens. The light from the objective lens is introduced to the spectrometer throughout a long pass filter, which can cutoff the light emission from the light source, such as 405 nm wavelength light, and a polarizer.

The light intensity of the peak emission wavelength polarized parallel and perpendicular to the average axis of the fibers of the each film is observed by the spectrometer.

Polarization ratio (hereafter “PR” for short) of emission is determined from the equation formula II.

PR={(Intensity of Emission)_{//}−(Intensity of Emission)_{⊥}}/{(Intensity of Emission)_{//}+(Intensity of Emission)_{⊥}} Equation formula II

In a preferred embodiment of the present invention, value of Sf is at least 0.1

More preferably, at least 0.4, even more preferably, at least 0.5, such as in the range from 0.5 to 0.9.

Preferably, the polarized light emissive film (100) emits visible light when it is illuminated by light source.

According to the present invention, the term “visible light” means light having a peak wavelength in the range from 380 nm-790 nm. Here, the peak wavelength of the visible light from the polarized light emissive film is longer than the peak wavelength of the light from light source used for illuminating the said polarized light emissive film.

Generally, the thickness of the polarized light emissive film (100) may be varied as desired.

In some embodiments, the polarized light emissive film (100) can have a thickness of at least 5 nm and/or at the most 10 mm.

Preferably, from 5 nm to 5 μm.

In some embodiments of the present invention, the polarized light emissive film (100) comprises two or more of stacked layers, in which each stacked layer can emit polarized visible light. Preferably, each layer emits different light wavelength when it is illuminated by a light source.

In a preferred embodiment of the present invention, the polarized light emissive film (100) consist of three stacked layers. More preferably, the three stacked layers consist of a blue polarized light emissive layer, green polarized light emissive layer, and red polarized light emissive layer.

In some embodiments, the plural of inorganic fluorescent semiconductor quantum rods (120) is selected from the group consisting of II-VI, III-V, IV-VI group semiconductors and a combination of any of these.

In a preferred embodiment of the present invention, inorganic fluorescent semiconductor quantum rods can be selected from the groups consisting of CdS, CdSe, CdTe, ZnS, ZnSe, ZnTe, ZnO, GaAs, GaP, GaAs, GaSb, HgS, HgSe, HgSe, HgTe, InAs, InP, InSb, AIAs, AIP, AISb, Cu₂S, Cu₂Se, CuInS2, CuInSe₂, Cu₂(ZnSn)S₄, Cu₂(InGa)S₄, TiO₂ alloys and a combination of any of these.

For example, for red emission use, CdSe rods, CdSe dot in CdS rod, ZnSe dot in CdS rod, CdSe/ZnS rods, InP rods, CdSe/CdS rods, ZnSe/CdS rods or a combination of any of these; for green emission use, such as CdSe rods, CdSe/ZnS rods, or a combination of any of these; and for blue emission use, such as ZnSe, ZnS, ZnSe/ZnS core shell rods and a combination of any of these can be used preferably.

Examples of inorganic fluorescent semiconductor quantum rods have been described in, for example, the international patent application laid-open No. WO2012/035535A or also in further patent documents and other publications known to the person skilled in the art.

In a preferred embodiment of the invention, the length of the overall structures of the inorganic fluorescent semiconductor quantum rods is from 5 nm to 500 nm. More preferably, from 10 nm to 160 nm. The overall diameter of the said inorganic fluorescent semiconductor quantum rods is in the range from 1 nm to 20 nm. More particularly, from 1 nm to 10 nm.

In some embodiments, the plural of the inorganic fluorescent semiconductor quantum rods comprises a surface ligand. Preferably, the surface of the inorganic fluorescent semiconductor quantum rods can be over coated with one or more kinds of surface ligands.

Without wishing to be bound by theory it is believed that such a surface ligands may lead to disperse the inorganic fluorescent semiconductor quantum rods in a solvent more easily.

The surface ligands in common use include phosphines and phosphine oxides such as Trioctylphosphine oxide (TOPO), Trioctylphosphine (TOP), and Tributylphosphine (TBP); phosphonic acids such as Dodecylphosphonic acid (DDPA), Tridecylphosphonic acid (TDPA), Octadecylphosphonic acid (ODPA), and Hexylphosphonic acid (HPA); amines, such as Dedecyl amine (DDA), Tetradecyl amine (TDA), Hexadecyl amine (HDA), and Octadecyl amine (ODA), preferably, poly (C2-C4) alkylene amines, such as poly ethylene imine (PEI); thiols such as hexadecane thiol and hexane thiol; mercapto carboxylic acids such as mercapto propionic acid and mercaptoundecanoicacid; and a combination of any of these.

Examples of surface ligands have been described in, for example, the international patent application laid-open No. WO 2012/035535A, or also in further patent documents and other publications known to the person skilled in the art.

Ligand exchange can be performed by methods described in, for example, Thomas Nann, Chemical Communication (2005), 1735-1736, or also in further publications and other patent documents known to the person skilled in the art.

In some embodiments of the invention, the light source of the polarized light emissive film (100) is Preferably, UV, near UV, or blue light source, such as UV, near UV or blue LED, CCFL, EL, OLED, xenon lamp or a combination of any of these.

For the purpose of the present invention, the term “near UV” is taken to mean a light wavelength in the range from 300 nm to 410 nm, the term “UV means a light wavelength in the range from 100 nm to 299 nm, and the term “blue” is taken to mean a light wavelength in the range from 411 nm to 495 nm.

In some embodiments, the average fiber diameter of the nanofibers is in a range from 5 nm to 2000 nm.

Preferably, it is in a range from 10 nm to 500 nm more preferably, from 10 nm to 95 nm

Turning to other components of the present invention, a transparent passivation layer can further be incorporated in the polarized light emissive film (100).

Preferably, the transparent passivation layer is placed on the plural of nanofibers (110) of the polarized light emissive film (100).

More preferably, the transparent passivation layer fully covers the plural of nanofibers like to encapsulate the plural of nanofibers.

In general, the transparent passivation layer can be flexible, semi-rigid or rigid. The transparent material for the transparent passivation layer is not particularly limited.

In a preferred embodiment, the transparent passivation layer is selected from the group consisting of a transparent polymer, transparent metal oxide (for example, oxide silicone, oxide aluminum, oxide titanium).

In general, the methods for preparing the transparent passivation layer can vary as desired and selected from well-known techniques.

In some embodiments, the transparent passivation layer can be prepared by a gas phase based coating process (such as Sputtering, Chemical Vapor Deposition, vapor deposition, flash evaporation), or a liquid-based coating process.

The term “liquid-based coating process” means a process that uses a liquid-based coating composition.

Here, the term “liquid-based coating composition” embraces solutions, dispersions, and suspensions.

More specifically, the liquid-based coating process can be carried out with at least one of the following processes: solution coating, ink jet printing, spin coating, dip coating, knife coating, bar coating, spray coating, roller coating, slot coating, gravure coating, flexographic printing, offset printing, relief printing, intaglio printing, or screen printing.

In another aspect, the invention relates to use of the polarized light emissive film (100) in an optical device.

In another aspect, the invention further relates to an optical device (130), wherein the optical device includes a polarized light emissive film (100) comprising a plural of nanofibers (110) aligned in one common direction; and a plural of inorganic fluorescent semiconductor quantum rods (120) aligned in the nanofibers approximately toward the long axis of the nanofibers.

In a preferred embodiment of the present invention, the optical device is selected from the group consisting of a Liquid crystal display, Q-rod display, color filter, polarized backlight unit, microscopy, metallurgy inspection and optical communications, or a combination of any of these.

More preferably, the polarized light emissive film (100) can be used as a part of a polarized LCD backlight unit.

Even more preferably, the polarized light emissive film (100) can be placed on top of a light guiding panel of a LCD backlight unit directly or indirectly across one or more of other layers.

In some embodiments, the LCD backlight unit optionally includes a reflector and/or a diffuser.

In a preferred embodiment, a reflector is placed under a light guiding panel side of the polarized light emissive film to reflect a light emission from the polarized light emissive film, and a diffuser is placed over the light emission side of the polarized light emissive film to increase the polarized light emission toward a LC cell.

Examples of optical devices have been described in, for example, WO 2010/095140 A2 and WO 2012/059931 A1.

In another aspect, the polarized light emissive film (100) of the present invention can preferably be prepared with electrospinning like described in for example, Zheng-Ming Huang et. al., Composites Science and Technology 63 (2003) 2223-2253 or also in further publications and other patent documents known to the person skilled in the art.

An outline of electrospinning of the present invention is as follows. A high voltage source 210 is provided to maintain an electrospinning unit 220 at a high voltage. An aligner 230 is placed preferably 1 to 100 cm away from the tip of the electrospinning unit 220. The aligner 230 can preferably be a rotatable drum or rotatable disk to wind & align the nanofibers on the drum or the disk. Typically, electric field strength in the range from 2,000 V/m to 400,000 V/m is established by the high voltage source 210. Nano fibers are produced by electrospinning from the electrospinning unit 220 in which is directed by the electric field toward the aligner 230.

In case of fabrication of a polarized limit emissive film, the tip of the electrospinning unit such as nozzle is moving perpendicular to the rotation direction of the aligner, such as drum, during electrospinning is carrying out to form a polarized light emissive film. Preferably rotating speed of the drum and/or disk is in the range from 1 rpm to 10,000 rpm.

Therefore, the present invention further relates to a method for preparing the polarized light emissive film (100),

wherein the method comprises the following sequential steps of:
(a) preparing a mixture containing the plural of inorganic fluorescent semiconductor quantum rods and a solvent;
(b) carrying out electro spinning with the mixture to form a nanofiber; and
(c) aligning the nanowire to form the polarized light emissive film.

In a preferred embodiment of the present invention, in step (c), aligning is effected by winding on a drum.

By changing drum rotating speed, electrospinning conditions, such as electric field strength, and/or components of the nanofibers, such as a sort of polymer medium, polarization ratio of the polarized light emissive film can be controlled accordingly.

Type of drum is not particularly limited.

In a preferred embodiment of the present invention, the drum has conducting surface consists of, such as a metal, conductive polymer, inorganic and/or organic semiconductor to discharge nanofibers. More preferably, the drum is a metal drum.

Preferably, rotating speed of the drum is in the range from 1 rpm to 100,000 rpm, more preferably, from 100 rpm to 6,000 rpm, further more preferably, it is in the range from 1,000 rpm to 5,000 rpm.

In a preferred embodiment, the solvent is water or an organic solvent. The type of organic solvent is not particularly limited.

More preferably, purified water or the organic solvent, which is selected from the group consisting of Methanol, Ethanol, Propanol, Isopropyl Alcohol, Butyl alcohol, Dimethoxyethane, Diethyl Ether, Diisopropyl Ether, Acetic Acid, Ethyl Acetate, Acetic Anhydride, Tetrahydrofuran, Dioxane, Acetone, Ethyl Methyl Ketone, Carbon tetrachloride, Chloroform, Dichloromethane, 1.2-Dichloroethane, Benzene, Toluene, o-Xylene, Cyclohexane, Pentane, Hexane, Heptane, Acetonitrile, Nitromethane, Dimethylformamide, Triethylamine, Pyridine, Carbon Disulfide, HFIP or a fluorophenol and a combination of any of these, can be used as the solvent. The even more preferably, purified water, toluene, HFIP or a fluorophenol.

Preferably, in step (a), a mixer or ultrasonicator can be used preferably to disperse the inorganic fluorescent semiconductor quantum rods into a solvent. A type of mixer or ultrasonicator is not particularly limited. In a further preferred embodiment, ultrasonicator is used in dispersing, with preferably under air condition.

In another aspect, the present invention also relates to method for preparing the optical device, wherein the method comprises the step of:

(x) providing the polarized the polarized light emissive film into an optical device.

In another aspect, the present invention further relates to a mixture comprising a plural of inorganic fluorescent semiconductor quantum rods having a surface ligand, polymer and solvent, wherein the surface ligand of the inorganic fluorescent semiconductor quantum rods is a polyalkylene amine; and the solvent is selected from the group consisting of hexafluoro-2-propanol (HFIP), a fluorophenol and a combination of any of these.

In a preferred embodiment of the present invention, the solvent is HFIP or pentafluorophenol.

In some embodiments, the polymer comprises a water insoluble polyester group.

Preferably, the water insoluble polyester group is selected from the group consisting of polyethylene terephthalate (PET), polylactic acid (PLA), poly trimethylene terephthalate (PTT), polybutylene terephthalate (PBT), polyethylene naphthalate (PEN), polybutylene naphthalate (PBN) or a combination of any of these.

Preferably, the polymer may consist of the water insoluble polyester group. Or the polymer may further comprise another one or more type of polymers.

In some embodiments, preferably the polyalkylene amine is a poly (C2-C4) alkylene amine in which selected from the group consisting of polyethylene amine, polypropylene amine, polybutylene amine and a combination of any of these. More preferably, it is polyethylene amine.

In another aspect, the present invention further relates to use of the mixture for preparing the polarized light emissive film.

In another aspect, the present invention also relates to a polarized light emissive nanofiber containing a polymer and an inorganic fluorescent semiconductor quantum rod having a surface ligand, wherein the polymer is a water insoluble polyester group and the surface ligand is polyalkylene amine.

In a preferred embodiment of the present invention, the polyalkylene amine is a poly (C2-C4) alkylene amine in which selected from the group consisting of polyethylene amine, polypropylene amine, polybutylene amine and a combination of any of these. More preferably, it is polyethylene amine.

In some embodiments, the water insoluble polyester group is selected from the group consisting of polyethylene terephthalate (PET), polylactic acid (PLA), poly trimethylene terephthalate (PTT), poly butylene terephthalate (PBT), polyethylene naphthalate (PEN), polybutylene naphthalate (PBN) or a combination of any of these.

Preferably, the polymer may consist of the water insoluble polyester group. Or the polymer may further comprise another one or more type of polymers.

In another aspect, the present invention further relates to use of the polarized light emissive nanofiber.

Preferably, for security purpose, such as for bills, the polarized light emissive nanofiber can be used.

In another aspect, the present invention also relates to method for preparing the polarized light emissive nanofiber, wherein the method comprises the following sequential steps of:

(a′) preparing a mixture containing the plural of inorganic fluorescent semiconductor quantum rods and a solvent;
(b′) carrying out electro spinning with the mixture

The working examples 1-4 below provide descriptions of the polarized light emissive films of the present invention, as well as an in detail description of their fabrication.

### DEFINITION OF TERMS

According to the present invention, the term “transparent” means at least around 60% of incident light transmittal at the thickness used in a polarized light emissive device and at a wavelength or a range of wavelength used during operation of a polarized light emissive device. Preferably, it is over 70%, more preferably, over 75%, the most preferably, it is over 80%.

The term “fluorescent” is defined as the physical process of light emission by a substance that has absorbed light or other electromagnetic radiation. It is a form of luminescence. In most cases, the emitted light has a longer wavelength, and therefore lower energy, than the absorbed radiation.

The term “semiconductor” means a material which has electrical conductivity to a degree between that of a conductor (such as copper) and that of an insulator (such as glass) at room temperature.

The term “inorganic” means any material not containing carbon atoms or any compound that containing carbon atoms ionically bound to other atoms such as carbon monoxide, carbon dioxide, carbonates, cyanides, cyanates, carbides, and thiocyanates.

The term “emission” means the emission of electromagnetic waves by electron transitions in atoms and molecules; and the term “emissive” is taken to mean physical property to emit a light when a substance having said physical property is absorbed by a light source.

Each feature disclosed in this specification, unless stated otherwise, may be replaced by alternative features serving the same, equivalent, or similar purpose. Thus, unless stated otherwise, each feature disclosed is but one example of a generic series of equivalent or similar features.

The invention is described in more detail in reference to the following examples, which are only illustrative and do not limit the scope of the invention.

### EXAMPLES

### Example 1: Fabrication of a Polarized Light Emissive Film with Polyethylene Oxide

Polyethylene imine (PEI)-covered nanocrystals having CdSe core and CdS shell were prepared by following procedure, described in such as Thomas Nann, Chemical Communication (2005), 1735-1736.

0.1 nmol of freshly precipitated Trioctylphosphine oxide (TOPO) coated nanocrystals having CdSe core and CdS shell (Qlight Technologies) were dispersed in 1 ml chloroform and 10 mg PEI (800D) solution. Then the resulting solution was settled for several hours to obtain the PEI covered nanocrystals.

Subsequently, the PEI covered nanocrystals were precipitated in 0.3 ml of cyclohexane and re-dispersed in water. Instead of water, any short—chained alcohols such as ethanol can be used in this way.

Finally, precipitation from water was done by addition of 1:1 mixture of chloroform and cyclohexane.

0.1 g of obtained polyethylene imine (PEI)-covered nanocrystals having CdSe core and CdS shell were dispersed in water (5 g) by ultrasonication using Branson chip sonicator (Branson Sonifier 250).

0.3 g of polyethylene oxide (PEO) having 60,000 molecular weight were dissolved in water (5 g) by stirrer.

5 ml of nanocrystals dispersed in water and 5 ml of PEO/water solution were mixed by stirrer.

Then the resulting solution was spun by an electrospinning.

A spun fiber was wound by a metal drum having 200 mm diameter and 300 mm width rotating at 3000 rpm. The nozzle for spinning was moving perpendicular to the rotation direction of the metal drum during winding. The fibers wound by a drum formed a 60 mm width sheet. Then, the film 1 was obtained.

In the same manner, the film 2 was also obtained.

### Example 2: Fabrication of Polarized Light Emissive Film with Polylactic Acid and a Bundle of Nanofibers with Polylactic Acid

Solution A

0.1 g of Polyethylene imine (PEI)-covered nanocrystals having CdSe core and CdS shell (Qlight Technologies) were dispersed in hexafluoro 2-propanol (hereinafter referred to as “HFIP” for short) (1.09 g) by ultrasonication using Branson chip sonicator (Branson Sonifier 250).

### Solution B

0.95 g of polylactic acid (PLA) having 60,000 molecular weight was dissolved in HFIP (7 g) by stirrer.

### Solution C

0.7 ml of the resulting solution A was added to 1.3 ml of the resulting solution B, and then it was mixed by stirrer. The weight ratio of PLA of the obtained solution C was 5.4% and the weight ratio of the nanocrystals was 0.48%.

### Solution D

Separately, 0.7 ml of the resulting solution A was added to 2.7 ml of the resulting solution B, and then it was mixed by stirrer. The weight ratio of PLA of the obtained solution D was 12% and the weight ratio of the nanocrystals was 0.50%.

Then, the resulting solution C was spun by an electrospinning. A spun fiber was wound by a metal drum having 200 mm diameter and 300 mm width rotating at 3000 rpm.

The nozzle for spinning was moving perpendicular to the rotation direction of the metal drum during winding.

The fibers wound by the metal drum formed the 60 mm width sheet consisting of nanocrystals dispersed fibers.

A bundle of nanofibers was fabricated in the same manner as the polarized light emissive film described in working example 2 except for a metal disk having 200 nm diameter and one mm width rotating 3000 rpm was used instead of the metal drum.

### Example 3: Evaluation of Polarized Light Emissive Films

The polarized light emissive films were evaluated by polarization microscope with spectrometer.

The two films from example 1 were excited by a 1 W, 405 nm light emitting diode, and the emission from the films was observed by a microscope with a 10 times objective lens. The light from the objective lens was introduced to the spectrometer throughout a long pass filter, which can cutoff 405 nm wavelength light, and a polarizer.

The light intensity of the peak emission wavelength polarized parallel and perpendicular to the average axis of the fibers of the each film were observed by the spectrometer.

Polarization ratio (hereafter “PR” for short) of the emission is determined from the equation formula II.

PR={(Intensity of Emission)_{//}−(Intensity of Emission)_{⊥}}/{(Intensity of Emission)_{//}+(Intensity of Emission)_{⊥}} Equation formula II

FIG. 2 shows the measurement results.

In the same manner, polarization ratio of the polarized light emissive film from example 2 was measured by polarization microscope with spectrometer. And measured polarization ratio was 0.52.

### Example 4: Evaluation of Light Emitting Uniformity of the Polarized Light Emissive Films

For this evaluation, one polarized light emitting film was fabricated in the same manner as described in example 2 except for 12 wt. % of polylactic acid, 0.5 wt. % of Polyethylene imine (PEI)-covered nanocrystals having CdSe core and CdS shell and 87.5 wt. % of HFIP was used.

Intentions of light emission of the film 1 were measured by polarization microscope with spectrometer on 1 cm*1 cm grid for 4 cm*4 cm area. (16 points)

Table 1 shows normalized light emitting intensities on each grid of the film.

| | 1 | 2 | 3 | 4 |
|---|---|---|---|---|
| 1 | 0.980 | 0.999 | 1.004 | 0.980 |
| 2 | 0.981 | 0.918 | 0.918 | 1.001 |
| 3 | 1.032 | 1.015 | 1.045 | 1.040 |
| 4 | 0.976 | 0.951 | 1.041 | 1.079 |

Standard deviation of the film was 0.04488. Approximately the standard deviation of example 4 was two times better than the standard deviation of comparative example 2.

### Comparative Example 1: Evaluation of Light Emitting Uniformity of the Polarized Light Emissive Film

As a comparative example, one polarized light emissive film was fabricated in the same manner as described in example 4 expect for spin coating method was used instead of electrospinning. Condition of spin coating was 1000 rpm for 20 seconds at room temperature, condition of baking after spincoating was 100° C. for 5 minutes at air.

### Comparative Example 2: Fabrication of the Polarized Light Emissive Film with Spincoating

As a comparative example, intentions of light emission of the film from comparative example 1 were measured in the same manner as described in example 4. (16 points)

Table 2 shows normalized light intensities on each grid of the film.

| | 1 | 2 | 3 | 4 |
|---|---|---|---|---|
| 1 | 1.316 | 1.104 | 0.919 | 1.072 |
| 2 | 0.990 | 1.016 | 0.990 | 0.912 |
| 3 | 1.023 | 1.046 | 1.003 | 0.993 |
| 4 | 1.023 | 0.977 | 0.958 | 0.997 |

Standard deviation was 0.09273.

1. A polarized light emissive film (100), comprising a plural of nanofibers (110) aligned in one common direction; and a plural of inorganic fluorescent semiconductor quantum rods (120) aligned in the nanofibers approximately toward the long axis of the nanofibers.

2. The polarized light emissive film (100) according to claim 1, wherein the polarized light emissive film emits a polarized light upon irradiation with a wavelength shorter than that of the emitted light.

3. The polarized light emissive film (100) according to claim 1, wherein the plural of inorganic fluorescent semiconductor quantum rods (120) is selected from the group consisting of II-VI, III-V, or IV-VI group semiconductors and a combination of any of these.

4. The polarized light emissive film (100) according to claim 1, wherein the plural of inorganic fluorescent semiconductor quantum rods (120) comprises a surface ligand.

5. The polarized light emissive film (100) according to claim 1, wherein the average fiber diameter of the nanofibers is in a range from 5 nm to 2,000 nm.

6. Use of the polarized light emissive film (100) according to claim 1 in an optical device.

7. An optical device (130), wherein the optical device includes a polarized light emissive film (100) according to claim 1 comprising a plural of nanofibers (110) aligned in one common direction; and a plural of inorganic fluorescent semiconductor quantum rods (120) aligned in the nanofibers approximately toward the long axis of the nanofibers.

8. Method for preparing the polarized light emissive film (100) according to claim 1, wherein the method comprises the following sequential steps of:
(a) preparing a mixture containing the plural of inorganic fluorescent semiconductor quantum rods and a solvent;
(b) carrying out electro spinning with the mixture to form a nanofiber
(c) aligning the nanowire in a common direction to form the polarized light emissive film.

9. Method according to claim 8, where aligning is effected by winding on a drum.

10. Method for preparing the optical device according to claim 7, wherein the method comprises the step of:
(x) providing the polarized light emissive film into the optical device.

11. A mixture comprising a plural of inorganic fluorescent semiconductor quantum rods having a surface ligand, polymer and solvent, wherein the surface ligand of the inorganic fluorescent semiconductor quantum rods is a polyalkylene amine; and the solvent is selected from the group consisting of hexafluoro-2-propanol (HFIP), a fluorophenol and a combination of any of these.

12. The mixture according to claim 11, wherein the polymer is a water insoluble polyester group.

13. Use of the mixture according to claim 11 for preparing the polarized light emissive film

14. A polarized light emissive nanofiber containing a polymer and an inorganic fluorescent semiconductor quantum rod having a surface ligand, wherein the polymer is a water insoluble polyester group and the surface ligand is polyalkylene amine.

15. A medium containing the polarized light emissive nanofiber according to claim 14.

16. Method for preparing the polarized light emissive nanofiber according to claim 14, wherein the method comprises the following sequential steps of:
(a′) preparing a mixture containing the plural of inorganic fluorescent semiconductor quantum rods and solvent;
(b′) carrying out electro spinning with the mixture.
